(19) United States
(12) Patent Application Publication
(10) Pub. No.: US 2024/0173632 A1
(43) Pub. Date: May 30, 2024

(54) DETERMINING LOCATION OF A PASSENGER VEHICLE BASED ON A COMPUTER MODEL AND SENSOR DEVICES

(71) Applicant: Disney Enterprises, Inc., Burbank, CA (US)

(72) Inventors: Patrick MCNAULL, Winter Garden, FL (US); Chun Sum YEUNG, Orlando, FL (US); Robert J. MARRA, Windermere, FL (US); Christopher C. HOFER, Ocoee, FL (US); Brian F. WALTERS, Groveland, FL (US)

(73) Assignee: Disney Enterprises, Inc., Burbank, CA (US)

(21) Appl. No.: 18/058,867

(22) Filed: Nov. 26, 2022

(51) Int. Cl. A63G 25/00; G01C 21/00

(52) U.S. Cl. CPC A63G 25/00; G01C 21/3844

(57) ABSTRACT

A vehicle location system may execute a model to simulate a movement of a passenger vehicle along a ride path. The vehicle location system may determine, based on executing the model, that a current ride location of the passenger vehicle is a first ride location. The vehicle location system may update a map application to indicate that the current ride location is the first ride location. The vehicle location system may receive sensor data generated by a sensor device located at a second ride location. The sensor data indicates that the passenger vehicle has been detected at the second ride location. The vehicle location system may provide the sensor data as an input to the model to update the current ride location to the second ride location. The vehicle location system may update, based on the sensor data, the map application to indicate the second ride location.

### BACKGROUND

A ride system includes a passenger vehicle that transports passengers through a ride experience. Typically, the passenger vehicle includes a system or device that propels the passenger vehicle through the ride experience, from one portion of the ride system to another portion of the ride system. A location of the passenger vehicle, along the ride system, may be tracked and information regarding the location may be provided to an operator the ride system.

### SUMMARY

In some implementations, a method performed by a vehicle location system includes executing a model to simulate a movement of a passenger vehicle along a ride path of a ride system; determining, based on executing the model, that a current ride location of the passenger vehicle is a first ride location of the ride system; updating a map application to indicate that the current ride location of the passenger vehicle is the first ride location, wherein the map application provides a visual indication of the current ride location of the passenger vehicle as the passenger vehicle moves along the ride system; receiving sensor data generated by a sensor device located at a second ride location of the ride system, wherein the sensor data indicates that the passenger vehicle has been detected at the second ride location; providing the sensor data as an input to the model to update the current ride location to the second ride location; and updating, based on the sensor data, the map application to indicate that the current ride location of the passenger vehicle is the second ride location.

In some implementations, a vehicle location system includes one or more memories; and one or more processors, coupled to the one or more memories, configured to: execute a model to simulate a movement of a passenger vehicle along a ride path of a ride system; determine, based on executing the model, that a current ride location of the passenger vehicle is a first ride location of the ride system; update a map application to indicate that the current ride location of the passenger vehicle is the first ride location, wherein the map application provides a visual indication of the current ride location of the passenger vehicle as the passenger vehicle moves along the ride system; receive sensor data generated by a sensor device located at a second ride location of the ride system, wherein the sensor data indicates that the passenger vehicle has been detected at the second ride location; provide the sensor data as an input to the model to update the current ride location to the second ride location; and update, based on the sensor data, the map application to indicate that the current ride location of the passenger vehicle is the second ride location.

In some implementations, a non-transitory computer-readable medium storing a set of instructions includes one or more instructions that, when executed by one or more processors of a vehicle location system, cause the vehicle location system to: execute a model to simulate a movement of a passenger vehicle along a ride path of a ride system; determine, based on executing the model, that a current ride location of the passenger vehicle is a first ride location of the ride system; update a map application to indicate that the current ride location of the passenger vehicle is the first ride location, wherein the map application provides a visual indication of the current ride location of the passenger vehicle as the passenger vehicle moves along the ride system; receive sensor data generated by a sensor device located at a second ride location of the ride system, wherein the sensor data indicates that the passenger vehicle has been detected at the second ride location; provide the sensor data as an input to the model to update the current ride location to the second ride location; and update, based on the sensor data, the map application to indicate that the current ride location of the passenger vehicle is the second ride location.

### BRIEF DESCRIPTION OF THE DRAWINGS

FIGS. 1A-IF are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to determining a location of a passenger vehicle.

### DETAILED DESCRIPTION

The following detailed description of example implementations refers to the accompanying drawings. The same reference numbers in different drawings may identify the same or similar elements.

A passenger vehicle may transport one or more passengers along a ride path of a ride system. Typically, a location of the passenger vehicle along the ride path is tracked as the passenger vehicle travels along the ride path. A ride path may be defined by a physical track, or may be defined by markers, wires or other guidance mechanisms in the case of trackless vehicles, and/or dynamically defined in the case of passenger steered vehicles. Information regarding the location of the passenger vehicle may be provided to a device of a ride operator to inform the ride operator of the location of the passenger vehicle. The information may be used by the ride operator to control (e.g., using the device) an operation of the ride system. For example, the information may be used to coordinate movements of the passenger vehicle and other passenger vehicles moving along the ride path and, thereby, prevent unintended operations of passenger vehicles of the ride system.

In most instances, the location of the passenger vehicle is only updated based on a trigger. For example, the location of the passenger vehicle may be updated when the passenger vehicle passes a sensor device provided at a known location along the ride path. In some instances, while multiple sensor devices may be provided along the ride path, the sensor devices may be far apart from each other (e.g., one sensor device may be provided at a significant distance from another sensor device). The significant distance between the sensor devices may cause a significant inaccuracy between an actual location of the passenger vehicle and an estimated location sensed (or determined) by a sensor device. The estimated location may be a known location of the sensor device.

In some instances, the ride system may be unable to provide any information regarding the location of the passenger vehicle (e.g., to the device of the ride operator) because sensor devices are not provided along the ride path. The inaccuracy of the location of the passenger vehicle and/or the unavailability of the location of the passenger vehicle may cause the ride operator to suspend the operation of the ride system in order to physically ascertain the location of the passenger vehicle. For example, the ride operator may walk along the ride path to ascertain the location of the passenger vehicle.

Ascertaining the location of the passenger vehicle in this manner is a time consuming process. Upon ascertaining the location of the passenger vehicle, the ride operator may resume the operation of the ride system. Suspending and resuming the operation of the ride system in this manner leads to lost time and extended downtimes with respect to the operation of the ride system. Additionally, suspending and resuming the operation of the ride system in this manner consumes computing resources associated with rebooting or reactivating devices associated with the ride system when the operation of the ride system resumes.

One solution may be to provide additional sensor devices along the ride path of the ride system. However, the additional sensor devices may consume bandwidth allocated for other devices associated with the ride system. Additionally, providing the additional sensor devices may consume computing resources, network resources, and/or storage resources associated with configuring the additional sensor devices to properly interact with the ride system. Additionally, or alternatively, providing the additional sensor devices increases an operating cost associated with operating the ride system.

Implementations described herein are directed to determining a ride location of a passenger vehicle as the passenger vehicle moves along a ride path of a ride system. The ride location may be determined based on executing a model to simulate a movement of the passenger vehicle along the ride path and based on updating the simulated movement of the passenger vehicle using sensor data of one or more sensor devices (provided along the ride path).

Information regarding the ride location of the passenger vehicle may be used to update a map location, of the passenger vehicle, of a map application that tracks the movement of the passenger vehicle as the passenger vehicle moves along the ride path. The map application may provide (e.g., output) a map (e.g., a human readable map) that identifies different ride locations of the passenger vehicle as the passenger vehicle moves along the ride path.

As used herein, a “ride location” may refer to a physical location of the passenger vehicle along the ride path of the ride system. As used herein, a “map location” may refer to a virtual location (e.g., on the map) that corresponds to a ride location.

The sensor devices may be provided at various ride locations of the ride system (e.g., various ride locations along the ride path). The sensor devices may be configured to detect a presence of the passenger vehicle at the various ride locations as the passenger vehicle travels past (or crosses) the sensor devices. As an example, a sensor device may generate sensor data based on detecting a presence of the passenger vehicle. The sensor data may indicate a ride location of the sensor device, which corresponds to a ride location of the passenger vehicle. The ride location of the passenger vehicle may be a location determined using dead reckoning.

The model may include a physics-based model (e.g., a physics-based computer model) that simulates the movement of the passenger vehicle along the ride path. For example, the model may use a physics engine that receives, as an input, vehicle information of the passenger vehicle and/or ride system information of the ride system. The model may generate, as an output, model data that includes information indicating various ride locations of the passenger vehicle along the ride path, as the movement of the passenger vehicle (along the ride path) is being simulated.

The ride locations, identified in the model data, may be estimated (or approximated) ride locations while the ride locations, identified in the sensor data, may be actual ride locations. As used herein, “vehicle information” may identify a mass of the passenger vehicle, a weight of the passenger vehicle, a size of the passenger vehicle (e.g., a length and/or a width of the passenger vehicle), a velocity of the passenger vehicle, and/or a load on a motor of the passenger vehicle, among other examples.

As used herein, “ride system information” may identify a geometry of the ride path, information regarding braking equipment provided along the ride path (e.g., an amount of friction applied to wheels of the passenger vehicle), information regarding one or more lifts provided along the ride path, information from a ride system controller of the ride system, an input from a human machine interface, information regarding one or more additional passenger vehicles of the ride system, information identifying a quantity of passenger vehicles of the ride system, orientations of one or more portions of the ride path, and/or sensor data from the sensor devices, among other examples. In some situations, the ride path may include a track.

In some implementations, the model may determine different ride locations of the passenger vehicle as the model simulates the movement of the passenger vehicle along the ride path. The different ride locations, determined by the model, may be estimated (or approximated) ride locations. As the passenger vehicle moves along the ride path, a first sensor device may detect a presence of the passenger vehicle at a first ride location of the ride system. The first sensor device may generate sensor data indicating that the passenger vehicle has been detected at the first ride location.

The sensor data may be used to update the movement, of the passenger vehicle, simulated by the model. For example, the sensor data may be provided as an input to the model. In some situations, because the sensor data identifies an actual ride location of the passenger vehicle, the sensor data may be provided as an input in order to improve a measure of accuracy of the movement of the passenger vehicle simulated by the model. The movement of the passenger vehicle, simulated by the model, may be updated to indicate that the passenger vehicle is located at the first ride location. The model may generate, as an output, model data regarding the first ride location. The model data may be used to update the map location, of the passenger vehicle, to indicate that the passenger vehicle is located at the first ride location.

The model may continue to simulate the movement of the passenger vehicle and may determine subsequent ride locations of the passenger vehicle until a second sensor device detects a presence of the passenger vehicle. For example, the model may determine the subsequent ride locations of the passenger vehicle based on the vehicle information of the passenger vehicle and/or the ride system information of the ride system. The model may generate model data regarding the subsequent ride locations. The model data may be used to update the map location, of the passenger vehicle, on the map application to reflect the subsequent ride locations of the passenger vehicle as the passenger vehicle moves along the ride path.

Based on the foregoing, implementations described herein enable the ride location of the passenger vehicle, at any time, to be made known to an operator of the ride system via the map application. In this regard, implementations described herein improve an accuracy of the ride location of the passenger vehicle with respect to determining the ride location using only sensor devices as described above.

By determining ride locations of the passenger vehicle as described herein, implementations described herein may preserve computing resources that would have been used to suspend and resume the operation of the ride system to manually ascertain the ride location of the passenger vehicle. Additionally, or alternatively, implementations described herein may preserve computing resources, network resources, and/or storage resources that would been used to install additional sensor devices and configure the additional sensor devices to properly interact with the ride system.

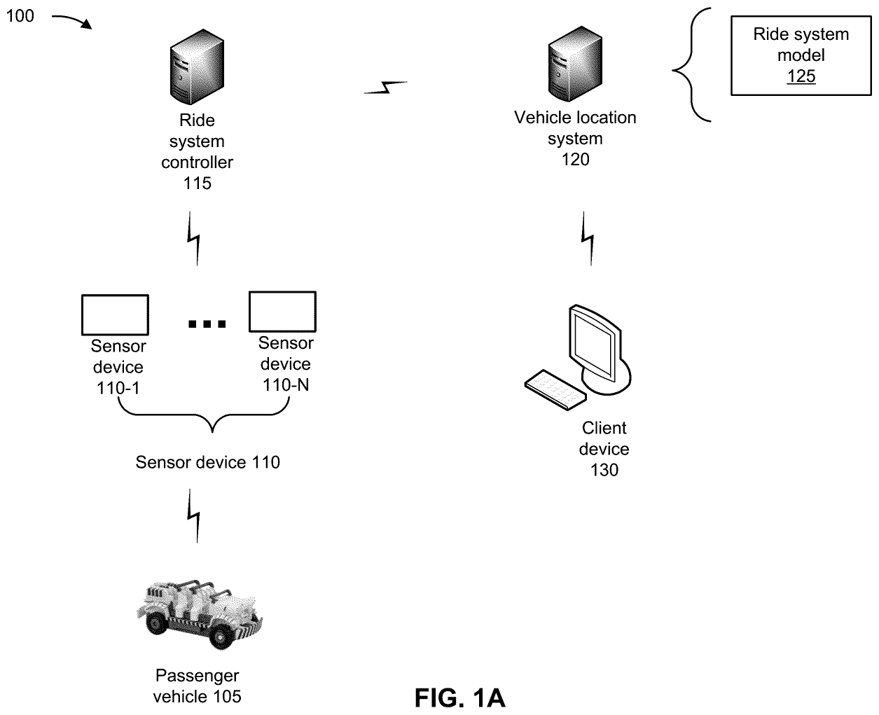

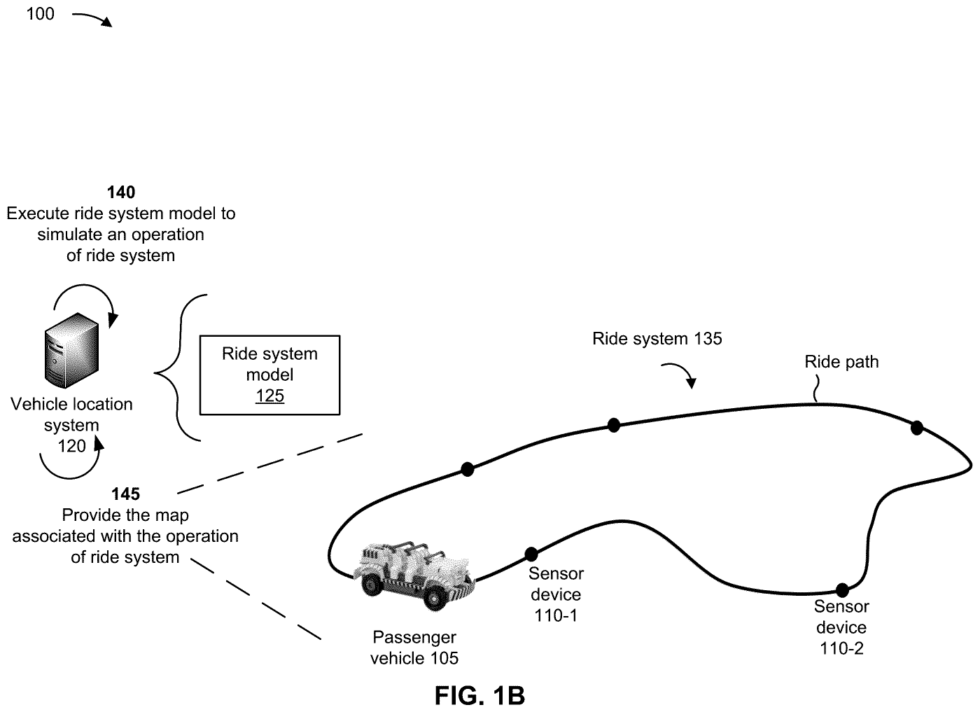

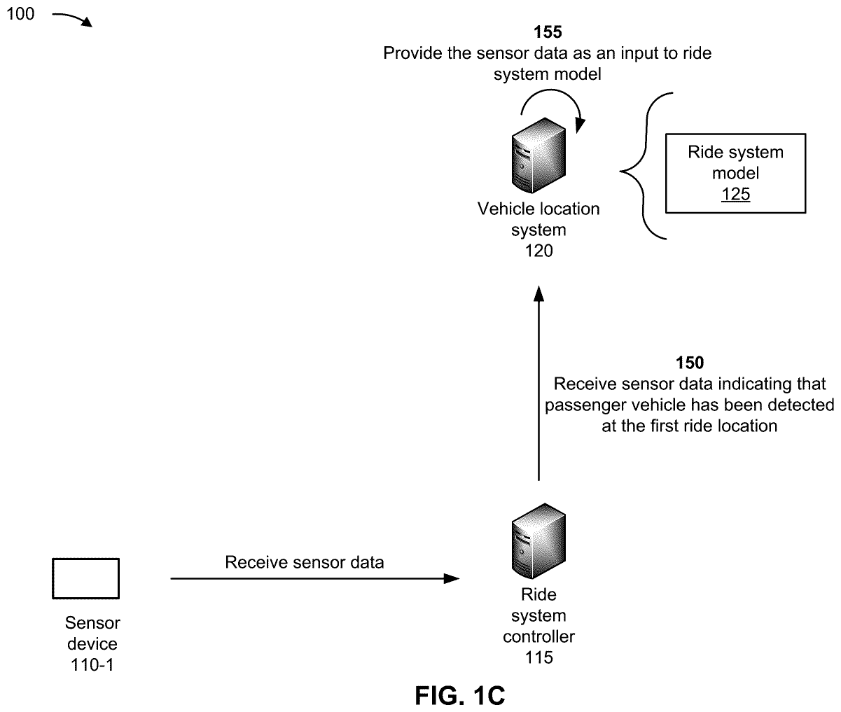

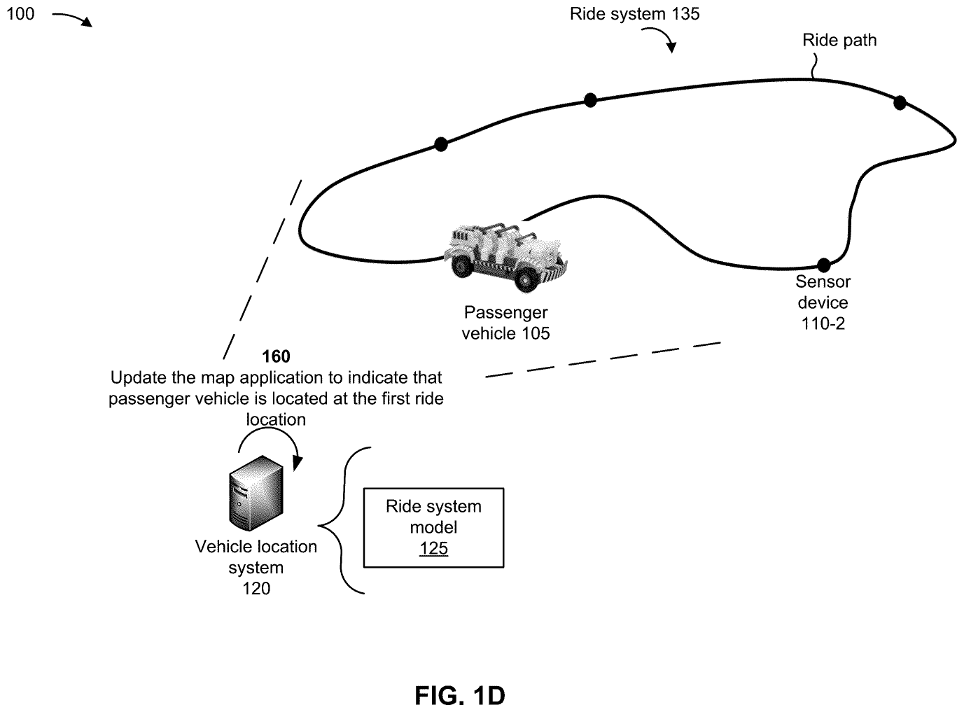

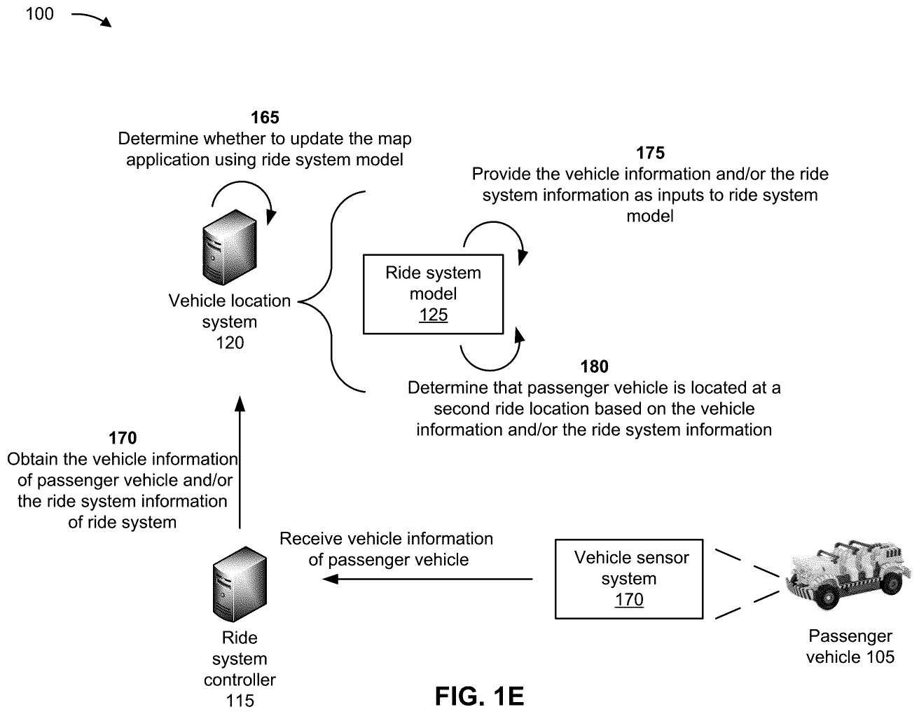

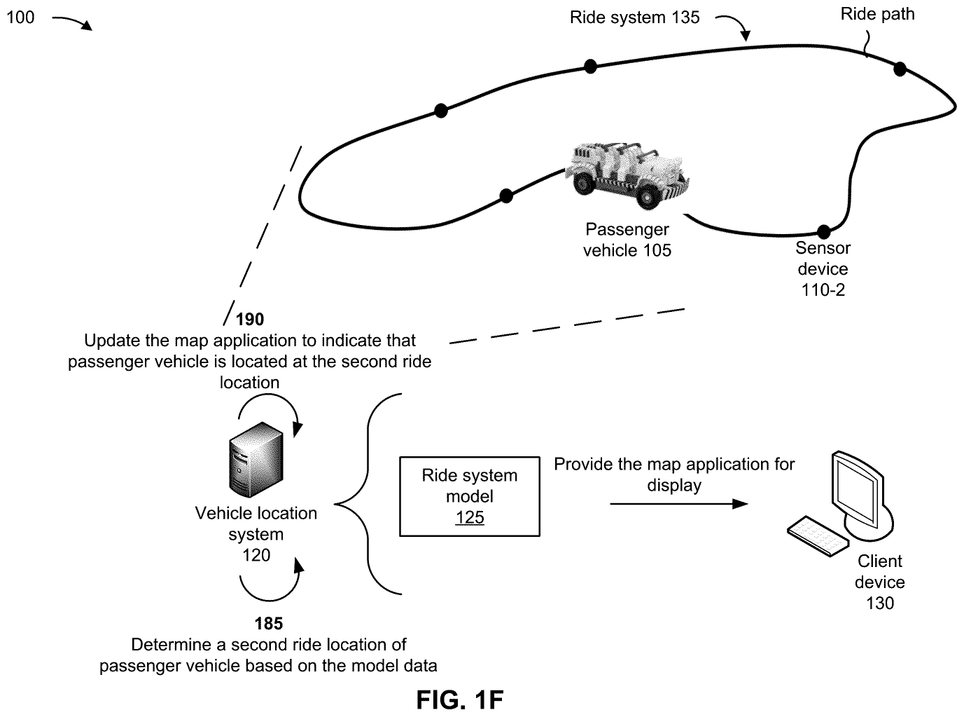

FIGS. 1A-IF are diagrams of an example implementation 100 associated with determining a ride location of a passenger vehicle based on sensor data and model data. As shown in FIGS. 1A-1F, example implementation 100 includes a passenger vehicle 105, a plurality of sensor devices 110 (individually referred to as sensor device 110), a ride system controller 115 of a ride system 135, a vehicle location system 120, and a client device 130.

Passenger vehicle 105 may include a vehicle that is configured to transport one or more passengers along a ride path of a ride system 135. In some implementations, passenger vehicle 105 may include a trackless vehicle in an amusement park, an autonomous vehicle, and/or an automated guided vehicle (AGVs), among other examples of vehicles. In some examples, passenger vehicle 105 may include a sensor system 170. Sensor system 170 may include one or more vehicle sensor devices.

The one or more vehicle sensor devices may be configured to sense a weight of passenger vehicle 105, a mass of passenger vehicle 105, a velocity of passenger vehicle 105, and/or a load on a motor of passenger vehicle 105, among other examples. The one or more vehicle sensor devices may be configured to generate information regarding the weight of passenger vehicle 105, the mass of passenger vehicle 105, the velocity of passenger vehicle 105, and/or the load on a motor of passenger vehicle 105, among other examples. The information may be included in vehicle information of passenger vehicle 105. The vehicle information may further include information identifying passenger vehicle 105 (e.g., a serial number, a model number, and/or information identifying a manufacturer of passenger vehicle 105, among other examples).

Passenger vehicle 105 may include a communication component (not shown). The communication component may include one or more devices that are capable of communicating with ride system controller 115 and/or with vehicle location system 120. For example, the communication component may provide the vehicle information to ride system controller 115 and/or to vehicle location system 120.

The communication component of passenger vehicle 105 may include a transceiver, a separate transmitter and receiver, an antenna, among other examples. The communication component may communicate with ride system controller 115 and/or with vehicle location system 120 using a wireless communication protocol such as, for example, BLUETOOTH® Low-Energy, BLUETOOTH®, Wi-Fi, near-field communication (NFC), Z-Wave, ZigBee, or Institute of Electrical and Electronics Engineers (IEEE) 802.154, among other examples.

A sensor device 110 may include one or more devices configured to sense (or determine) information regarding an operation of ride system 135 and generate sensor data regarding the operation of ride system 135. For example, the sensor device 110 may be configured to detect a presence of passenger vehicle 105 (e.g., passenger vehicle 105 travel past the sensor device 110 along the ride path). The sensor device 110 may generate sensor data based on detecting the presence of passenger vehicle 105. As an example, the sensor device 110 may be a motion sensor device.

The sensor data may include information identifying the sensor device 110, information identifying a ride location of the sensor device 110, information identifying a date and/or a time when the presence of passenger vehicle 105 was detected, and/or the information identifying passenger vehicle 105, among other examples. The information identifying the sensor device 110 may include a serial number, a model number, and/or information identifying a manufacturer of the sensor device 110, among other examples.

Ride system controller 115 may include one or more devices configured to control an operation of ride system 135. For example, ride system controller 115 generates and sends analog or digital signals communicated to either or both of ride vehicle 105 and that are used by onboard and wayside systems to actuate motors, linear inductive motors (LIMs) brakes, pacers and the like to affect the speed and/or direction of passenger vehicle 105. For example, ride system controller 115 may be configured to control a movement of passenger vehicle 105 and movements of one or more additional passenger vehicles. For instance, ride system controller 115 may be configured to cause passenger vehicle 105 to be in motion (e.g., in one or more directions), cause passenger vehicle 105 to be stationary, increase a velocity of passenger vehicle 105, decrease the velocity, among other examples.

Additionally or alternatively to controlling the movement, ride system controller 115 may control an operation of braking equipment provide along the ride path, and/or control orientations of one or more portions of the ride path, among other examples. In some implementations, ride system controller 115 may include a programmable logic controller. In some situations, the programmable logic controller may be referred to as a wayside ride control system (WRCS).

Vehicle location system 120 may include one or more devices configured to determine ride locations of one or more passenger vehicles (including passenger vehicle 105) of ride system 135. For example, vehicle location system 120 may be configured to determine the ride location of passenger vehicle 105 based on model data of a ride system model 125 executed by vehicle location system 120 and/or based on sensor data from one or more sensor devices 110.

Ride system model 125 may include a computer model that is configured to simulate an operation of ride system 135. The computer model may be a physics-based computer model that is configured to simulate the operation of ride system 135. For example, ride system model 125 may include a physics engine that is configured to simulate movements of the one or more passenger vehicles of ride system 135 (e.g., a movement of passenger vehicle 105).

In some implementations, ride system model 125 may receive, as inputs, information generated by one or more physical components associated with ride system 135. For example, ride system model 125 may receive, as inputs, sensor data from sensor devices 110, vehicle information of the one or more passenger vehicles of ride system 135, and/or ride system information of ride system 135. Additionally, or alternatively, ride system model 125 may receive inputs for physical attributes, such as vehicle weight, passenger weight, passenger weight distribution, applied motor power, and/or friction or air resistance parameters, among other examples. Ride system model 125 may simulate movements of the one or more passenger vehicles, along the ride path, based on the inputs.

Ride system model 125 may generate, as an output, model data that includes ride location information indicating various ride locations of the one or more passenger vehicles along the ride path as the movements, of the one or more passenger vehicles along the ride path, are being simulated. As used herein “ride location information” (of a passenger vehicle) may refer to information identifying ride locations of the passenger vehicle along the ride path.

In some implementations, the model data may be used to update a map application associated with an operation of ride system 135. For example, the map application may be executed to provide a map of ride system 135. In some implementations, the map application may be executed as part of an execution of ride system model 125. Alternatively, the map application may be executed independently of the execution of ride system model 125. The map may provide graphical elements representing the ride path, the one or more passenger vehicles, and/or braking equipment, among other examples. The map may indicate map locations, of the one or more passenger vehicles, that correspond to ride locations of ride system 135. The map may be rendered in two dimensions or three dimensions and may be visually presented monoptically, stereoscopically, as a hologram or any other available display technology that aids in visualizing the model data.

Client device 130 may include one or more devices configured to provide the map for display (e.g., to an operator of ride system 135). For example, client device 130 may be a device of the operator of ride system 135. In some implementations, vehicle location system 120 may provide the map to client device 130 to cause client device 130 to display the map after the map has been updated. In some implementations, client device 130 may execute the map application. In this regard, client device 130 may receive the ride location information of the one or more passenger vehicles, update the map application based on the ride system information, and provide the map for display after updating the map application.

As shown in FIG. 1B, and by reference number 140, vehicle location system 120 may execute ride system model 125 to simulate an operation of ride system 135. For example, vehicle location system 120 may receive a request to simulate the operation of ride system 135 and may execute ride system model 125 to simulate the operation of ride system 135 based on the request. The request may be received from client device 130. For example, client device 130 may provide the request as passenger vehicle 105 moves along the ride path of the ride system or as passenger vehicle 105 is about to start moving along the ride path.

In some situations, based on the request, vehicle location system 120 may obtain last location information identifying a last known ride location of passenger vehicle 105, obtain the vehicle information of passenger vehicle 105, obtain the ride system information of ride system 135, among other examples. In some situations, vehicle location system 120 may obtain the last location information, the vehicle information, and/or the ride system information from ride system controller 115.

Vehicle location system 120 may provide the last location information, the vehicle information, and/or the ride system information as inputs to ride system model 125. Vehicle location system 120 may cause ride system model 125 to be executed based on the inputs. In some examples, based on the inputs, vehicle location system 120 may simulate the operation of ride system 135. For instance, based on the inputs, vehicle location system 120 may simulate the movement of passenger vehicle 105 along a ride path of ride system 135.

As an example, based on the last known ride location of passenger vehicle 105 and based on a velocity of passenger vehicle 105, ride system model 125 may determine using the physics-based model (or estimate) a current ride location of passenger vehicle 105 after a period of time elapses (e.g., following a date and/or a time associated with the last known ride location). The last known ride location may be a last current ride location and the date and/or the time may be a date and/or a time when the last current ride location was determined (e.g., by ride system model 125).

Additionally, or alternatively to the last known ride location and the velocity of passenger vehicle 105, ride system model 125 may determine (or estimate) the current ride location of passenger vehicle 105 further based on a mass of passenger vehicle 105, based on a weight of passenger vehicle 105, based on an amount friction applied to wheels of passenger vehicle 105, based on an orientation of one or more portions of the ride path, among other examples. Ride system model 125 may determine the current ride location of passenger vehicle 105 periodically (e.g., every half second, every second, among other examples) or at other time intervals.

Ride system model 125 may generate, as an output, model data identifying the current ride location of passenger vehicle 105. For example, the model data may be pre-visualization data identifying the current ride location. In some situations, the current ride location may be a starting ride location for all passenger vehicles. As an example, the starting ride location may be a loading/unloading station.

As shown in FIG. 1B, and by reference number 145, vehicle location system 120 may provide a map associated with the operation of ride system 135. For example, the map may be generated based on the map application being executed. In some implementations, the map application may be executed based on the request. In some implementations, the map application may be executed as part of executing ride system model 125. Alternatively, the map application may be executed independently of the request and/or of ride system model 125.

Vehicle location system 120 may update the map based on the model data generated by ride system model 125. For example, vehicle location system 120 may update the map to cause a graphical element of passenger vehicle 105 to be moved to a map location corresponding to the current ride location of passenger vehicle 105. Vehicle location system 120 may provide the map. For example, vehicle location system 120 may provide the map to client device 130 to cause client device 130 to display the map (e.g., to the operator of ride system 135).

As shown in FIG. 1C, ride system controller 115 may receive sensor data from sensor device 110-1 located at a first ride location of ride system 135. For example, as passenger vehicle 105 continues to move along the ride path of ride system 135, sensor device 110-1 may detect a presence of passenger vehicle 105 at the first ride location. Based on detecting the presence of passenger vehicle 105 at the first ride location, sensor device 110-1 may generate sensor data indicating that passenger vehicle 105 has been detected at the first ride location.

The sensor data may include ride location information identifying the first ride location. In some implementations, sensor device 110-1 may provide the sensor data to ride system controller 115. Additionally, or alternatively, sensor device 110-1 may provide the sensor data to vehicle location system 120. When sensor devices 110 are at fixed locations, the sensor data may simply identify the sensor and its activation state (e.g., an activation state that indicates an object is present or not present).

As shown in FIG. 1C, and by reference number 150, vehicle location system 120 may receive the sensor data indicating that passenger vehicle 105 has been detected at the first ride location. For example, vehicle location system 120 may receive the sensor data from ride system controller 115. Additionally, or alternatively, vehicle location system 120 may receive the sensor data from sensor device 110-1.

As shown in FIG. 1C, and by reference number 155, vehicle location system 120 may provide the sensor data as an input to ride system model 125. For example, based on receiving the sensor data, vehicle location system 120 may determine that the first ride location (identified the ride location information) is an actual ride location of passenger vehicle 105. In this regard, vehicle location system 120 may determine that the sensor data (e.g., the ride location information) may improve a measure of accuracy of the movement of passenger vehicle 105 simulated by the model. Accordingly, vehicle location system 120 may provide the sensor data as an input to ride system model 125 to improve the measure of accuracy of the movement of passenger vehicle 105 simulated by the model. Based on the sensor data, ride system model 125 may update the model data to generate updated model data. The updated model data may include updated ride location information identifying the first ride location.

As shown in FIG. 1D, and by reference number 160, vehicle location system 120 may update the map application to indicate that passenger vehicle 105 is located at the first ride location. For example, vehicle location system 120 may update the map (of the map application) to cause the graphical element, representing passenger vehicle 105, to be moved from a current map location to a map location corresponding to the first route location. In some implementations, vehicle location system 120 may update the map based on the updated model data. Alternatively, vehicle location system 120 may update the map based on the sensor data.

As shown in FIG. 1E, and by reference number 165, vehicle location system 120 may determine whether to update the map application using ride system model 125. As explained above, ride system model 125 may determine the current ride location of passenger vehicle 105 periodically. Vehicle location system 120 may be configured to update the map application in accordance with a same periodicity. For example, may periodically determine whether sensor data has been obtained from a sensor device 110. For example, vehicle location system 120 may identify a next sensor device 110 along the ride path and determine whether sensor data has been received from the next sensor device 110 within a particular period of time corresponding to the periodicity. Alternatively, the map can be updated at irregular intervals based on, for example, a desired level of location granularity at a particular portion of the ride path. Moreover, the update interval may be altered dynamically to reflect emergent conditions during the ride operation (e.g., during an evacuation procedure higher granularity may be desired as compared to normal operation).

In some implementations, vehicle location system 120 may determine (or identify) the next sensor device 110 using a data structure that stores information regarding sensor devices 110. For example, the information regarding sensor devices 110 may be stored in an order indicating a sequence of sensor device 110 along the ride path. The information regarding a sensor device 110 may include information identifying the sensor device 110, information identifying a ride location of the sensor device 110, information identifying a next sensor device 110, and/or information identifying a ride location of the next sensor device 110, among other examples.

The sensor data, provided by sensor device 110-1, may include information identifying sensor device 110-1. In this regard, vehicle location system 120 may perform a lookup of the data structure, using the information identifying sensor device 110-1, to determine the next sensor device 110 (subsequent to sensor device 110-1). Vehicle location system 120 may determine that the map application is to be updated using ride system model 125 after determining that sensor data has not received from the next sensor device 110 with the particular period of time.

Additionally, or alternatively to determining whether the sensor data has been received from the next sensor device 110, vehicle location system 120 may determine whether passenger vehicle 105 is located between sensor device 110-1 and the next sensor device 110. Vehicle location system 120 may determine whether passenger vehicle 105 is located between sensor device 110-1 and the next sensor device 110 based on model data of ride system model 125. Vehicle location system 120 may determine that the map application is to be updated using ride system model 125 after determining that passenger vehicle 105 is located between sensor device 110-1 and the next sensor device 110.

Additionally, or alternatively to determining whether passenger vehicle 105 is located between sensor device 110-1 and the next sensor device 110, vehicle location system 120 may determine whether a distance between sensor device 110-1 and the next sensor device 110 satisfies a distance threshold. Vehicle location system 120 may determine the distance based on a distance between the first ride location and a ride location of the next sensor device 110.

Vehicle location system 120 may determine that the map application is to be updated using ride system model 125 after determining that the distance satisfies a distance threshold. For example, the distance satisfying the distance threshold may indicate an increased measure of inaccuracy with respect to determining the current ride location of passenger vehicle 105. For instance, waiting for the sensor data of the next sensor device 110 to determine the current ride location of passenger vehicle 105 may subject the current ride location to an increased measure of inaccuracy.

As shown in FIG. 1E, and by reference number 170, vehicle location system 120 may obtain the vehicle information of passenger vehicle 105 and/or the ride system information of ride system 135. For example, based on determining that the map application is to be updated using ride system model 125, vehicle location system 120 may obtain the vehicle information and/or the ride system information. For instance, vehicle location system 120 may provide a request to ride system controller 115 for the vehicle information and/or the ride system information. Vehicle location system 120 may obtain the vehicle information and/or the ride system information based on the request. In some implementations, vehicle location system 120 may obtain the vehicle information and/or the ride system information periodically.

As shown in FIG. 1E, passenger vehicle 105 may provide the vehicle information to ride system model 125. Additionally, or alternatively, passenger vehicle 105 may provide the vehicle information to vehicle location system 120.

As shown in FIG. 1E, and by reference number 175, vehicle location system 120 may provide the vehicle information and/or the ride system information as inputs to ride system controller 115. Vehicle location system 120 may provide the vehicle information and/or the ride system information as inputs to ride system model 125 to cause ride system model 125 to determine a current ride location of passenger vehicle 105 using the inputs.

As shown in FIG. 1E, and by reference number 180, ride system model 125 may determine that passenger vehicle 105 is located at a second ride location based on the vehicle information and/or the ride system information. For example, ride system model 125 may determine that the current ride location of passenger vehicle 105 is the second ride location in a manner similar to the manner described herein. Ride system model 125 may further update the model data to generate an updated model data indicating that passenger vehicle 105 is located at the second ride location. In some examples, the second ride location may be a ride location between the first ride location of sensor device 110-1 and a third ride location of the next sensor device 110.

As shown in FIG. 1F, and by reference number 190, vehicle location system 120 may update the map application to indicate that passenger vehicle 105 is located at the second ride location. For example, vehicle location system 120 may update the map application using the updated model data as described herein.

As shown in FIG. 1F, vehicle location system 120 may provide the map application for display. For example, vehicle location system 120 may provide the map application to client device 130 for display.

By updating the map application as described herein, implementations described herein may preserve computing resources that would have been used to suspend and resume the operation of the ride system. Additionally, or alternatively, implementations described herein may preserve computing resources, network resources, and/or storage resources that would been used to install additional sensor devices and configure the additional sensor devices to properly interact with the ride system.

As indicated above, FIGS. 1A-IF are provided as an example. Other examples may differ from what is described with regard to FIGS. 1A-1F. The number and arrangement of devices shown in FIGS. 1A-IF are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-IF may be implemented as multiple, distributed devices. Additionally, or alternatively, a set of devices (e.g., one or more devices) shown in FIGS. 1A-IF may perform one or more functions described as being performed by another set of devices shown in FIGS. 1A-1F.

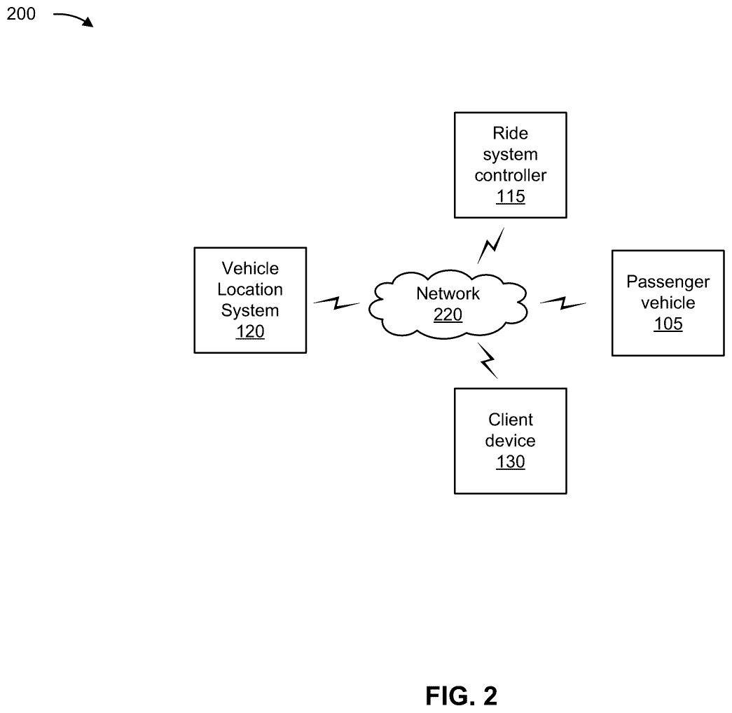

FIG. 2 is a diagram of an example environment 200 in which systems and/or methods described herein may be implemented. Some elements of environment 200 have been described above in connection with FIG. 1. In some implementations, vehicle location system 120 may include one or more elements of and/or may execute within a cloud computing system. As further shown in FIG. 2, environment 200 may include passenger vehicle 105, ride system controller 115, client device 130, and/or a network 220. Devices and/or elements of environment 200 may interconnect via wired connections and/or wireless connections.

In some situations, vehicle location system 120 may include a server, such as an application server, a client server, a web server, a database server, a host server, a proxy server, a virtual server (e.g., executing on computing hardware), or a server in a cloud computing system. In some implementations, vehicle location system 120 includes computing hardware used in a cloud computing environment.

Client device 130 includes one or more devices capable of receiving, generating, storing, processing, and/or providing information associated with determining a ride location of passenger vehicle 105, as described elsewhere herein. Client device 130 may include a communication device and a computing device. For example, client device 130 may include a wireless communication device, a mobile phone, a user equipment, a laptop computer, a tablet computer, a desktop computer, or a similar type of device.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

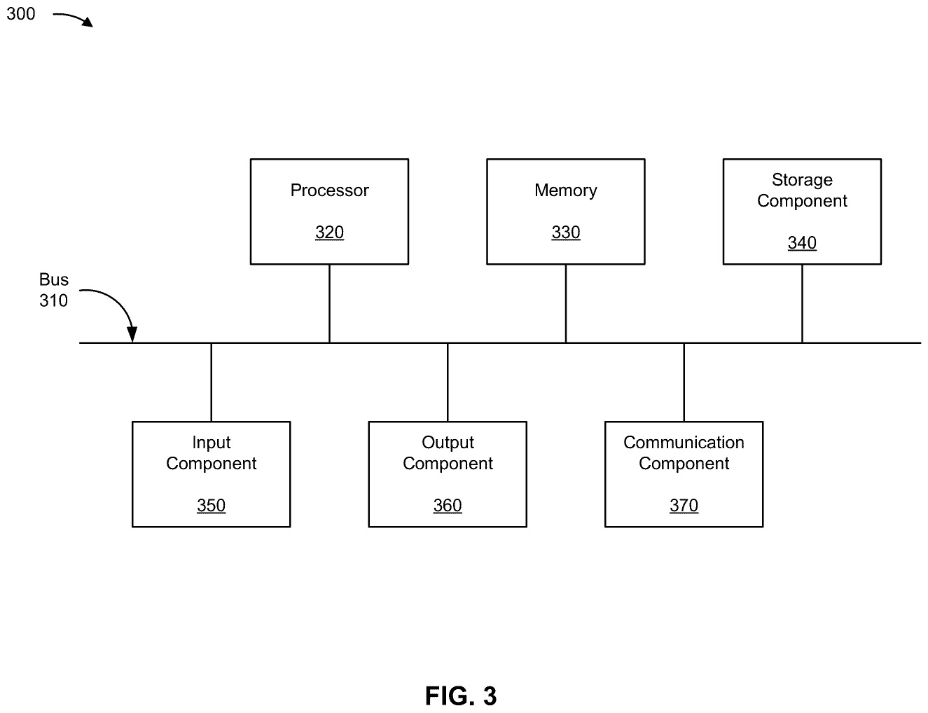

FIG. 3 is a diagram of example components of a device 300, which may correspond to ride system controller 115, vehicle location system 120, and/or client device 130. In some implementations, passenger vehicle 105, ride system controller 115, vehicle location system 120, and/or client device 130 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

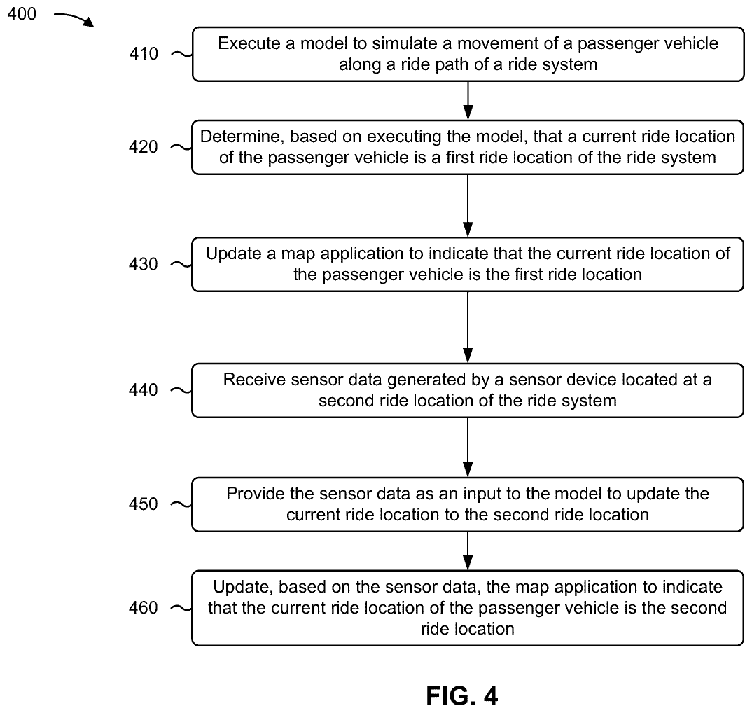

FIG. 4 is a flowchart of an example process 400 associated with determining a location of a passenger vehicle. In some implementations, one or more process blocks of FIG. 4 may be performed by a vehicle location system (e.g., vehicle location system 120). In some implementations, one or more process blocks of FIG. 4 may be performed by another device or a group of devices separate from or including the vehicle location system, such as a passenger vehicle (e.g., passenger vehicle 105), a ride system controller (e.g., ride system controller 115), and/or a client device (e.g., client device 130). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include executing a model to simulate a movement of a passenger vehicle along a ride path of a ride system (block 410). For example, the vehicle location system may execute a model to simulate a movement of a passenger vehicle along a ride path of a ride system, as described above.

As further shown in FIG. 4, process 400 may include determining, based on executing the model, that a current ride location of the passenger vehicle is a first ride location of the ride system (block 420). For example, the vehicle location system may determine, based on executing the model, that a current ride location of the passenger vehicle is a first ride location of the ride system, as described above.

As further shown in FIG. 4, process 400 may include updating a map application to indicate that the current ride location of the passenger vehicle is the first ride location (block 430). For example, the vehicle location system may update a map application to indicate that the current ride location of the passenger vehicle is the first ride location, wherein the map application provides a visual indication of the current ride location of the passenger vehicle as the passenger vehicle moves along the ride system, as described above. In some implementations, the map application provides a visual indication of the current ride location of the passenger vehicle as the passenger vehicle moves along the ride system.

As further shown in FIG. 4, process 400 may include receiving sensor data generated by a sensor device located at a second ride location of the ride system, wherein the sensor data indicates that the passenger vehicle has been detected at the second ride location (block 440). For example, the vehicle location system may receive sensor data generated by a sensor device located at a second ride location of the ride system, wherein the sensor data indicates that the passenger vehicle has been detected at the second ride location, as described above.

As further shown in FIG. 4, process 400 may include providing the sensor data as an input to the model to update the current ride location to the second ride location (block 450). For example, the vehicle location system may provide the sensor data as an input to the model to update the current ride location to the second ride location, as described above.

As further shown in FIG. 4, process 400 may include updating, based on the sensor data, the map application to indicate that the current ride location of the passenger vehicle is the second ride location (block 460). For example, the vehicle location system may update, based on the sensor data, the map application to indicate that the current ride location of the passenger vehicle is the second ride location, as described above.

In some implementations, executing the model comprises executing a computer model that uses a physics engine to simulate the movement of the passenger vehicle along a track of the ride system.

In some implementations, determining that the current ride location of the passenger vehicle is the first ride location comprises providing, as an input to the model, last location information regarding the passenger vehicle and vehicle information regarding the passenger vehicle, wherein the last location information identifies a last ride location of the passenger vehicle, and wherein the vehicle information identifies one or more of a mass of the passenger vehicle, a weight of the passenger vehicle, or a velocity of the passenger vehicle, and obtaining, as an output of the model, model data indicating that the current ride location is the first ride location, wherein the model data is generated based on the last location information and the vehicle information.

In some implementations, updating the map application based on the sensor data comprises obtaining, as an output of the model, model data indicating that the current ride location is the first ride location, wherein the model data is generated, by the model, based on the sensor data, and updating the map application using the model data.

In some implementations, the sensor data is first sensor data and the sensor device is a first sensor device of a plurality of sensor devices located at different ride locations of the ride system, and wherein the method further comprises determining whether second sensor data, from a second sensor device of the plurality of sensor devices, has been received, determining that the current ride location of the passenger vehicle is to be determined without the second sensor data based on determining that the second sensor data has not been received, and determining, based on executing the model, that the current ride location of the passenger vehicle is a third ride location of the ride system based on determining that the current ride location of the passenger vehicle is to be determined without the second sensor data.

In some implementations, the sensor device is a first sensor device of a plurality of sensor devices located at different ride locations of the ride system, and wherein the method further comprises determining that the passenger vehicle is located between the first sensor device and a second sensor device of the plurality of sensor devices, determining that the current ride location of the passenger vehicle is to be determined without second sensor data from the second sensor device based on determining that the second sensor data has not been received, and determining, based on executing the model, that the current ride location of the passenger vehicle is a third ride location of the ride system based on determining that the current ride location of the passenger vehicle is to be determined without the second sensor data.

In some implementations, determining that the current ride location of the passenger vehicle is to be determined without the second sensor data comprises determining that a distance between the first sensor device and the second sensor device satisfies a distance threshold, and determining that the current ride location of the passenger vehicle is to be determined without the second sensor data based on determining that the distance satisfies the distance threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a vehicle location system, the method comprising:
executing a model to simulate a movement of a passenger vehicle along a ride path of a ride system;
determining, based on executing the model, that a current ride location of the passenger vehicle is a first ride location of the ride system;
updating a map application to indicate that the current ride location of the passenger vehicle is the first ride location,
wherein the map application provides a visual indication of the current ride location of the passenger vehicle as the passenger vehicle moves along the ride system;
receiving sensor data generated by a sensor device located at a second ride location of the ride system, wherein the sensor data indicates that the passenger vehicle has been detected at the second ride location;
providing the sensor data as an input to the model to update the current ride location to the second ride location; and
updating, based on the sensor data, the map application to indicate that the current ride location of the passenger vehicle is the second ride location.

2. The method of claim 1, wherein executing the model comprises:
executing a computer model that uses a physics engine to simulate the movement of the passenger vehicle along a track of the ride system.

3. The method of claim 2, wherein determining that the current ride location of the passenger vehicle is the first ride location comprises:
providing, as an input to the model, last location information regarding the passenger vehicle and vehicle information regarding the passenger vehicle,
wherein the last location information identifies a last ride location of the passenger vehicle, and
wherein the vehicle information identifies one or more of a mass of the passenger vehicle, a weight of the passenger vehicle, or a velocity of the passenger vehicle; and
obtaining, as an output of the model, model data indicating that the current ride location is the first ride location,
wherein the model data is generated based on the last location information and the vehicle information.

4. The method of claim 1, wherein updating the map application based on the sensor data comprises:
obtaining, as an output of the model, model data indicating that the current ride location is the first ride location,
wherein the model data is generated, by the model, based on the sensor data; and updating the map application using the model data.

5. The method of claim 1, wherein the sensor data is first sensor data and the sensor device is a first sensor device of a plurality of sensor devices located at different ride locations of the ride system, and
wherein the method further comprises:
determining whether second sensor data, from a second sensor device of the plurality of sensor devices, has been received;
determining that the current ride location of the passenger vehicle is to be determined without the second sensor data based on determining that the second sensor data has not been received; and
determining, based on executing the model, that the current ride location of the passenger vehicle is a third ride location of the ride system based on determining that the current ride location of the passenger vehicle is to be determined without the second sensor data.

6. The method of claim 1, wherein the sensor device is a first sensor device of a plurality of sensor devices located at different ride locations of the ride system, and
wherein the method further comprises:
determining that the passenger vehicle is located between the first sensor device and a second sensor device of the plurality of sensor devices;
determining that the current ride location of the passenger vehicle is to be determined without second sensor data from the second sensor device based on determining that the second sensor data has not been received; and
determining, based on executing the model, that the current ride location of the passenger vehicle is a third ride location of the ride system based on determining that the current ride location of the passenger vehicle is to be determined without the second sensor data.

7. The method of claim 6, wherein determining that the current ride location of the passenger vehicle is to be determined without the second sensor data comprises:
determining that a distance between the first sensor device and the second sensor device satisfies a distance threshold; and
determining that the current ride location of the passenger vehicle is to be determined without the second sensor data based on determining that the distance satisfies the distance threshold.

8. A vehicle location system, comprising:
one or more memories; and
one or more processors, coupled to the one or more memories, configured to:
execute a model to simulate a movement of a passenger vehicle along a ride path of a ride system;
determine, based on executing the model, that a current ride location of the passenger vehicle is a first ride location of the ride system;
update a map application to indicate that the current ride location of the passenger vehicle is the first ride location,
wherein the map application provides a visual indication of the current ride location of the passenger vehicle as the passenger vehicle moves along the ride system;
receive sensor data generated by a sensor device located at a second ride location of the ride system, wherein the sensor data indicates that the passenger vehicle has been detected at the second ride location;
provide the sensor data as an input to the model to update the current ride location to the second ride location; and
update, based on the sensor data, the map application to indicate that the current ride location of the passenger vehicle is the second ride location.

9. The vehicle location system of claim 8, wherein the one or more processors, to execute the model, are configured to:
execute a computer model that uses a physics engine to simulate the movement of the passenger vehicle along a track of the ride system.

10. The vehicle location system of claim 9, wherein the one or more processors, to determine that the current ride location of the passenger vehicle is the first ride location, are configured to:
provide, as an input to the model, last location information regarding the passenger vehicle and vehicle information regarding the passenger vehicle,
wherein the last location information identifies a last ride location of the passenger vehicle, and
wherein the vehicle information identifies one or more of a mass of the passenger vehicle, a weight of the passenger vehicle, or a velocity of the passenger vehicle; and
obtain, as an output of the model, model data indicating that the current ride location is the first ride location,
wherein the model data is generated based on the last location information and the vehicle information.

11. The vehicle location system of claim 8, wherein the one or more processors, to update the map application based on the sensor data, are configured to:
obtain, as an output of the model, model data indicating that the current ride location is the first ride location,
wherein the model data is generated, by the model, based on the sensor data; and update the map application using the model data.

12. The vehicle location system of claim 8, wherein the sensor data is first sensor data and the sensor device is a first sensor device of a plurality of sensor devices located at different ride locations of the ride system, and
wherein the method further comprises:
determine whether second sensor data, from a second sensor device of the plurality of sensor devices, has been received;
determine that the current ride location of the passenger vehicle is to be determined without the second sensor data based on determining that the second sensor data has not been received; and
determine, based on executing the model, that the current ride location of the passenger vehicle is a third ride location of the ride system based on determining that the current ride location of the passenger vehicle is to be determined without the second sensor data.

13. The vehicle location system of claim 8, wherein the sensor device is a first sensor device of a plurality of sensor devices located at different ride locations of the ride system, and
wherein the method further comprises:
determine that the passenger vehicle is located between the first sensor device and a second sensor device of the plurality of sensor devices;
determine that the current ride location of the passenger vehicle is to be determined without second sensor data from the second sensor device based on determining that the second sensor data has not been received; and
determine, based on executing the model, that the current ride location of the passenger vehicle is a third ride location of the ride system based on determining that the current ride location of the passenger vehicle is to be determined without the second sensor data.

14. The vehicle location system of claim 13, wherein the one or more processors, to determine that the current ride location of the passenger vehicle is to be determined without the second sensor data, are configured to:
determine that a distance between the first sensor device and the second sensor device satisfies a distance threshold; and
determine that the current ride location of the passenger vehicle is to be determined without the second sensor data based on determining that the distance satisfies the distance threshold.

15. A non-transitory computer-readable medium storing a set of instructions, the set of instructions comprising:
one or more instructions that, when executed by one or more processors of a vehicle location system, cause the vehicle location system to:
execute a model to simulate a movement of a passenger vehicle along a ride path of a ride system;
determine, based on executing the model, that a current ride location of the passenger vehicle is a first ride location of the ride system;
update a map application to indicate that the current ride location of the passenger vehicle is the first ride location,
wherein the map application provides a visual indication of the current ride location of the passenger vehicle as the passenger vehicle moves along the ride system;
receive sensor data generated by a sensor device located at a second ride location of the ride system, wherein the sensor data indicates that the passenger vehicle has been detected at the second ride location;
provide the sensor data as an input to the model to update the current ride location to the second ride location; and
update, based on the sensor data, the map application to indicate that the current ride location of the passenger vehicle is the second ride location.

16. The non-transitory computer-readable medium of claim 15, wherein the one or more instructions, that cause the vehicle location system to execute the model, cause the vehicle location system to:
execute a computer model that uses a physics engine to simulate the movement of the passenger vehicle along a track of the ride system.

17. The non-transitory computer-readable medium of claim 16, wherein the one or more instructions, that cause the vehicle location system to determine that the current ride location of the passenger vehicle is the first ride location, cause the vehicle location system to:
provide, as an input to the model, last location information regarding the passenger vehicle and vehicle information regarding the passenger vehicle,
wherein the last location information identifies a last ride location of the passenger vehicle, and
wherein the vehicle information identifies one or more of a mass of the passenger vehicle, a weight of the passenger vehicle, or a velocity of the passenger vehicle; and
obtain, as an output of the model, model data indicating that the current ride location is the first ride location,
wherein the model data is generated based on the last location information and the vehicle information.

18. The non-transitory computer-readable medium of claim 15, wherein the one or more instructions, that cause the model to update the map application based on the sensor data, cause the model to:
obtain, as an output of the model, model data indicating that the current ride location is the first ride location,
wherein the model data is generated, by the model, based on the sensor data; and update the map application using the model data.

19. The non-transitory computer-readable medium of claim 15, wherein the sensor data is first sensor data and the sensor device is a first sensor device of a plurality of sensor devices located at different ride locations of the ride system, and
wherein the one or more instructions further cause the vehicle location system to:
determine whether second sensor data, from a second sensor device of the plurality of sensor devices, has been received;
determine that the current ride location of the passenger vehicle is to be determined without the second sensor data based on determining that the second sensor data has not been received; and
determine, based on executing the model, that the current ride location of the passenger vehicle is a third ride location of the ride system based on determining that the current ride location of the passenger vehicle is to be determined without the second sensor data.

20. The non-transitory computer-readable medium of claim 15, wherein the sensor device is a first sensor device of a plurality of sensor devices located at different ride locations of the ride system, and
wherein the one or more instructions further cause the vehicle location system to:
determine that the passenger vehicle is located between the first sensor device and a second sensor device of the plurality of sensor devices;
determine that the current ride location of the passenger vehicle is to be determined without second sensor data from the second sensor device based on determining that the second sensor data has not been received; and
determine, based on executing the model, that the current ride location of the passenger vehicle is a third ride location of the ride system based on determining that the current ride location of the passenger vehicle is to be determined without the second sensor data.
